(19) United States
(12) Patent Application Publication
(10) Pub. No.: US 2026/0049705 A1
(43) Pub. Date: Feb. 19, 2026

(54) LIGHT SOURCE STRUCTURE

(71) Applicant: Xiamen Topstar Lighting Co., Ltd., Xiamen (CN)

(72) Inventors: Yongjie WU, Xiamen (CN); Yunbiao WU, Xiamen (CN); Wenda WEN, Xiamen (CN)

(73) Assignee: Xiamen Topstar Lighting Co., Ltd., Xiamen (CN)

(21) Appl. No.: 19/367,401

(22) Filed: Oct. 23, 2025

(30) Foreign Application Priority Data
Sep. 8, 2025 (CN) 202521926472.X

(51) Int. Cl. F21V 3/02; F21K 9/66; F21V 3/04; F21V 29/70

(52) U.S. Cl. CPC F21V 3/02; F21K 9/66; F21V 3/049; F21V 29/70

(57) ABSTRACT

A light source structure includes an outer diffusion cover, a transparent plastic shell, and a colored inner diffusion cover. The plastic shell is provided with a first opening, the plastic shell is sleeved outside the inner diffusion cover, the outer diffusion cover is arranged at the first opening in a covering manner, a heat sink is arranged inside the inner diffusion cover, a main light source assembly is arranged on one side face of the heat sink, and a backlight source assembly is arranged on the other side face of the heat sink, thus realizing dual functions of conventional lighting and soft atmosphere lighting.

### CROSS-REFERENCE TO RELATED APPLICATIONS

This application claims priority to Chinese Patent Application No. 202521926472.X, filed on September 8, 2025, the contents of which are incorporated herein by reference.

### TECHNICAL FIELD

This disclosure relates to the technical field of lighting devices, and in particular, to a light source structure.

### BACKGROUND

The existing light source products include, for example, bulged reflector bulbs (BR bulbs), A-series light bulbs (also often called pear-shaped bulbs or standard-shaped bulbs), and globe shape bulbs (also called spherical bulbs). Taking the BR bulb as an example, there are technical solutions of setting a two-layer cover structure for a main light source and setting a backlight source separately in the known technology.

### SUMMARY

This disclosure relates to a light source structure, including an outer diffusion cover, a transparent plastic shell, and a colored inner diffusion cover, where the plastic shell is sleeved outside the inner diffusion cover, and the outer diffusion cover and the plastic shell enclose to form an outer shell of the light source structure; and a heat sink is arranged inside the inner diffusion cover, the heat sink is provided with a main light source assembly at one side facing the outer diffusion cover and is provided with a backlight source assembly at one side facing the plastic shell, and the backlight source assembly is electrically connected to the main light source assembly.

### BRIEF DESCRIPTION OF THE DRAWINGS

FIG. 1 is a structural schematic diagram when a light source structure is a BR bulb according to some embodiments of this disclosure.

FIG. 2 is a sectional view when a light source structure is a BR bulb according to some embodiments of this disclosure.

FIG. 3 is an enlarged view of part A in FIG. 2 of a light source structure according to some embodiments of this disclosure.

FIG. 4 is a structural schematic diagram of a heat sink and a backlight source assembly of a light source structure according to some embodiments of this disclosure.

FIG. 5 is a sectional view of a heat sink of a light source structure according to some embodiments of this disclosure.

FIG. 6 is an enlarged view of part D in FIG. 5.

FIG. 7 is a structural schematic diagram of a heat sink and a main light source assembly of a light source structure according to some embodiments of this disclosure.

FIG. 8 is an exploded view when a light source structure is a BR bulb according to some embodiments of this disclosure.

FIG. 9 is a structural schematic diagram when a light source structure is a globe shape bulb according to some embodiments of this disclosure.

FIG. 10 is a sectional view when a light source structure is a globe shape bulb according to some embodiments of this disclosure.

FIG. 11 is an enlarged view of part B in FIG. 9 of a light source structure according to some embodiments of this disclosure.

FIG. 12 is an exploded view when a light source structure is a globe shape bulb according to some embodiments of this disclosure.

FIG. 13 is a structural schematic diagram when a light source structure is an A-series light bulb according to some embodiments of this disclosure.

FIG. 14 is a sectional view when a light source structure is an A-series light bulb according to some embodiments of this disclosure.

FIG. 15 is an enlarged view of part C in FIG. 13 of a light source structure according to some embodiments of this disclosure.

FIG. 16 is an exploded view when a light source structure is an A-series light bulb according to some embodiments of this disclosure.

### DETAILED DESCRIPTION OF THE EMBODIMENTS

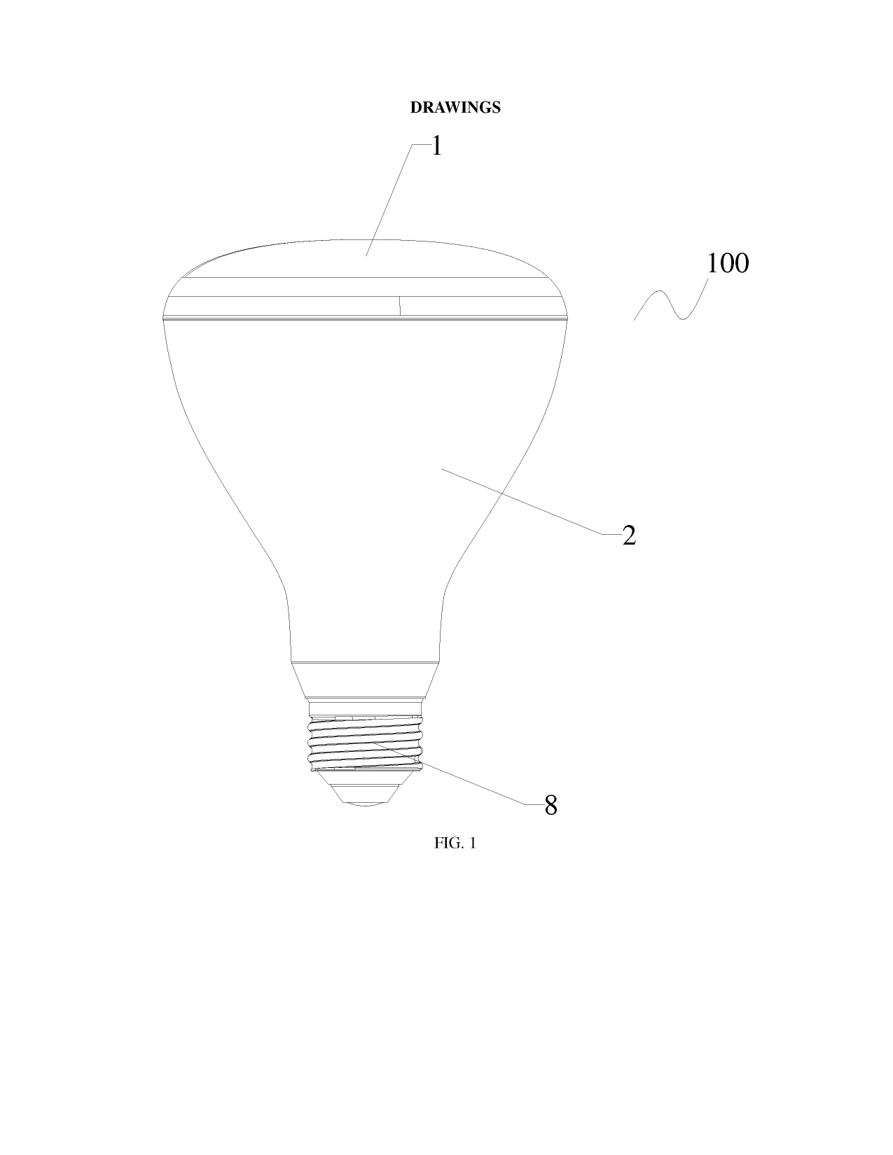

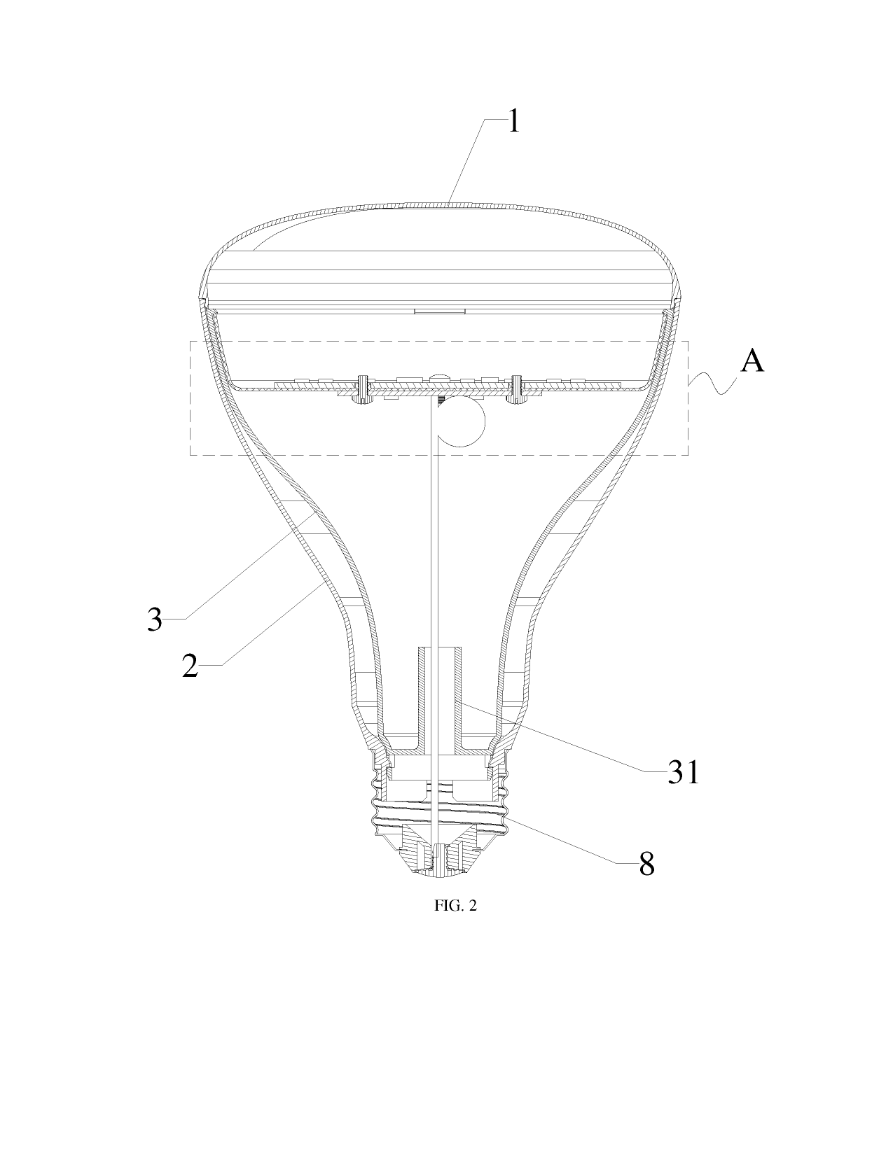

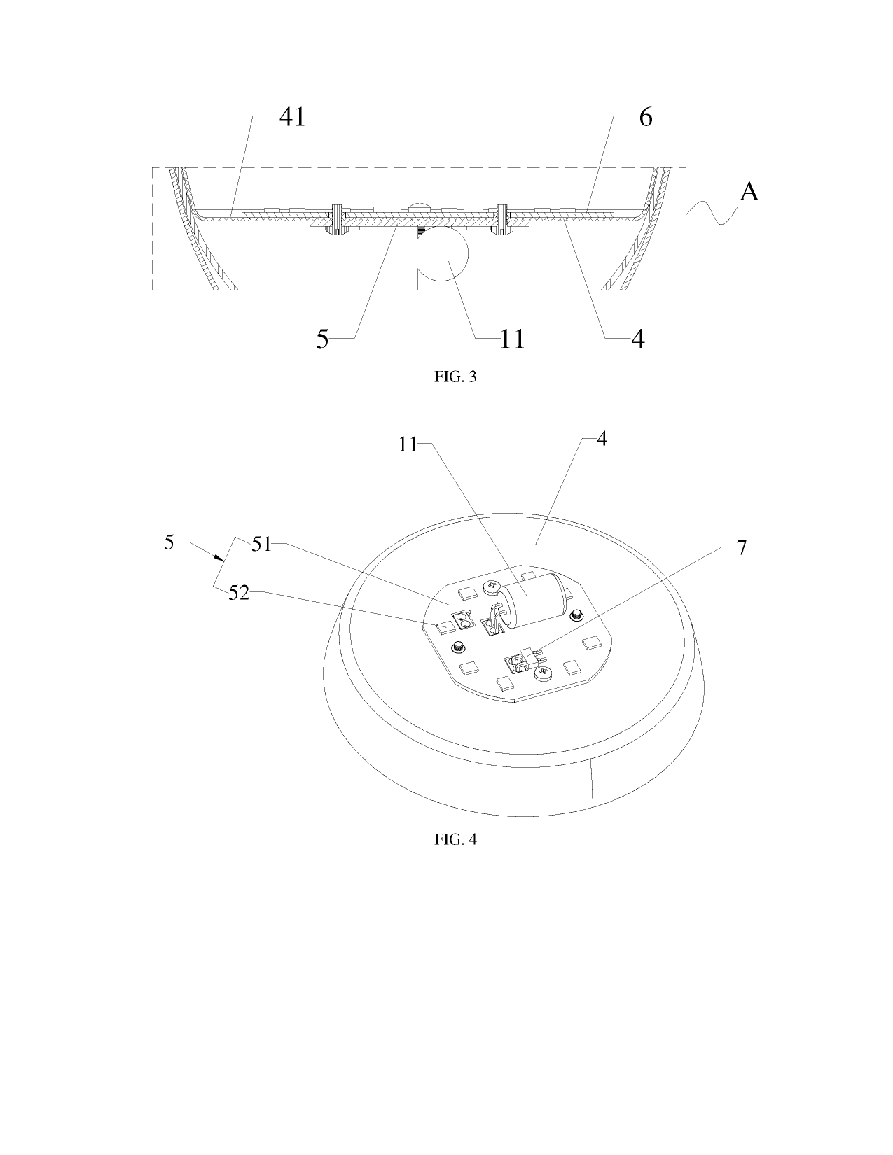

According to some embodiments of this disclosure, referring to FIG. 1, FIG. 2, and FIG. 3, a light source structure 100 includes an outer diffusion cover 1, a transparent plastic shell 2, and a colored inner diffusion cover 3, where the plastic shell 2 is sleeved outside the inner diffusion cover 3, and the outer diffusion cover 1 and the plastic shell 2 enclose to form an outer shell (1 and 2) of the light source structure 100; and a heat sink 4 is arranged inside the inner diffusion cover 3, the heat sink 4 is provided with a main light source assembly 6 at one side facing the outer diffusion cover 1 and is provided with a backlight source assembly 5 at one side facing the plastic shell 2, and the backlight source assembly 5 is electrically connected to the main light source assembly 6.

In the above embodiments, the heat sink 4 is used as a carrier, and the main light source assembly 6 is arranged at the side of the heat sink facing the outer diffusion cover 1, so as to realize a conventional front lighting function of a traditional light source. Meanwhile, the backlight source assembly 5 is arranged at the side of the heat sink 4 facing the plastic shell, and is matched with the colored inner diffusion cover 3 and the transparent plastic shell 2, so that a light emitting direction of the backlight source assembly 5 is towards the inner diffusion cover 3, instead of directly illuminating a user's activity area, thereby avoiding direct lighting of bright light; and the transparent plastic shell 2 allows the soft light treated by the inner diffusion cover 3 to penetrate smoothly, forming a “surrounding” soft lighting form from the back and side of a lamp body, which is more suitable for the requirements of “low-range and local lighting” of a night lamp (for example, a bedside night lamp only needs to light the area around the bed) and “large-area and background lighting” of atmosphere lighting (for example, a living room lamp lights the wall through back light to form indirect atmosphere light), thus realizing dual functions of conventional lighting and soft atmosphere lighting. The inner diffusion cover 3 in this solution is arranged inside the plastic shell 2, which can shield the main light source assembly 6, the backlight source assembly 5, the heat sink 4, and internal electronic components, to avoid seeing messy devices from the outside on the one hand, and can diffuse and soften the light from the backlight source assembly 5, to ensure the softness of light of the night lamp and atmosphere lighting on the other hand.

In some embodiments, referring to FIG. 2, the inner diffusion cover 3 is amber in color, and the inner diffusion cover 3 can be made into different colors according to requirements, or an ivory inner diffusion cover can be used in conjunction with an RGB light source to emit light of different colors.

Amber has the natural characteristics of light softening and tone harmonizing, which can filter the light emitted by the backlight source assembly 5 as warm and soft tones, perfectly adapt to night lamps, bedroom atmosphere lighting, and other scenarios, and solve the problem that traditional light sources are easily affected in use due to dazzling light if they are forcibly used as night lamps. In addition, the amber diffusion cover has a better shielding effect on the internal structure than a transparent or light-colored diffusion cover, which can further hide the heat sink 4 and the light source assembly, and improve the product appearance tidiness.

In some embodiments, a visible light transmittance of the inner diffusion cover 3 ranges from 65% to 87%.

This light transmittance range is precisely designed for renovation requirements of traditional light sources. Less than 65% may lead to excessive attenuation of the light from the backlight source, which cannot meet basic brightness requirements of night lamps or atmosphere lighting; higher than 85% may lead to the exposure of outlines of the internal heat sink 4 and electronic components, which cannot realize a structure-hiding effect; and the light transmittance of 65% to 87% can not only ensure that the light from the backlight source assembly 5 effectively penetrates and remains soft, but also completely shield the internal structure while having no impact on the normal propagation of the light from the main light source, thus ensuring that the brightness of the conventional lighting will not be compromised.

In some embodiments, referring to FIG. 2, an inner surface of one end of the inner diffusion cover 3 facing away from the outer diffusion cover 1 is provided with a threading post 31 extending in an axial direction of the inner diffusion cover 3, and the threading post 31 is integrally formed together with the inner diffusion cover 3.

If an LN power cord (where L represents a live wire and N represents a neutral wire) of traditional light source products is directly arranged on a shell inner wall, it is easy to form a shadow under light source lighting, thus affecting the lighting aesthetics. The LN power cord can be fixed through the arrangement of the threading post 31, which prevents the power cord from sticking to the outer wall of the inner diffusion cover 3, solves the problem of shadow caused by power cord shielding when the light from the backlight source assembly 5 is illuminated, and ensures the integrity and uniformity of back lighting.

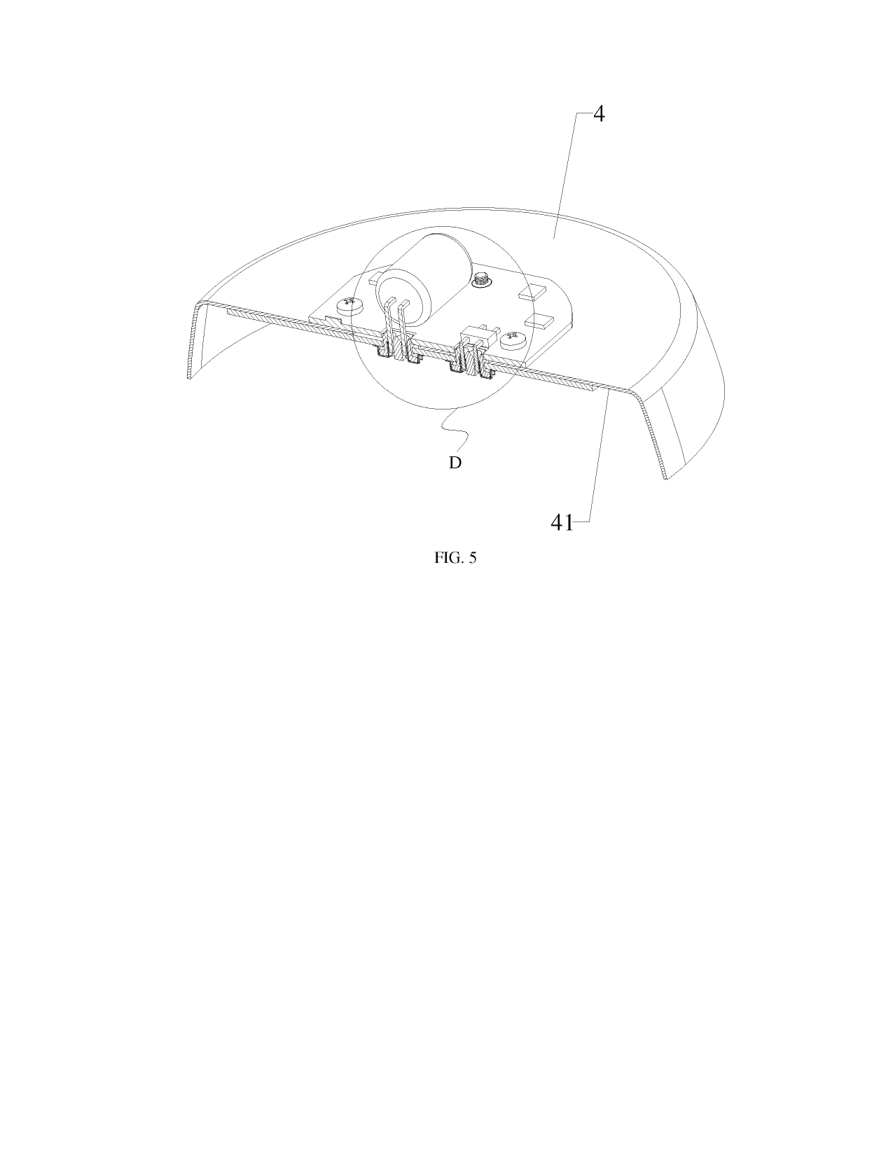

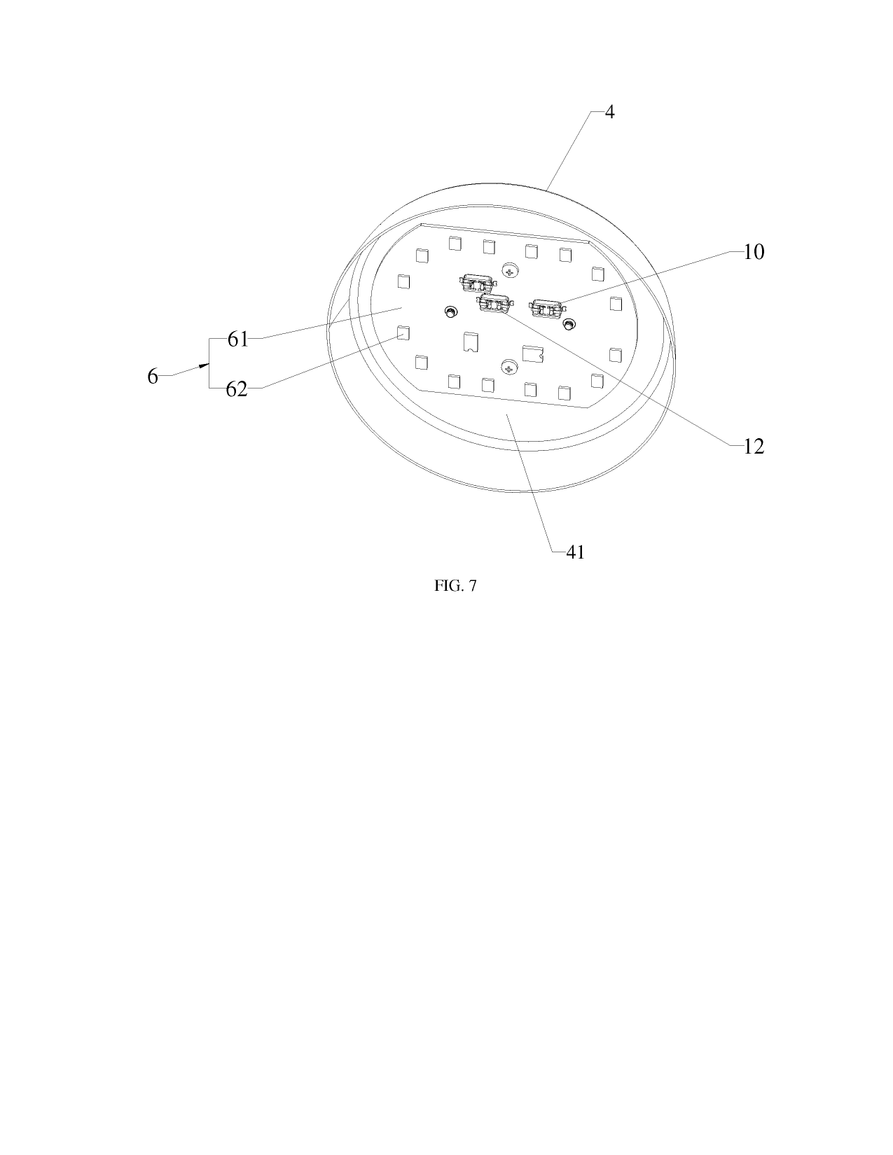

In some embodiments, referring to FIG. 4 and FIG. 6, the heat sink 4 is in a circular truncated cone shape, a side wall of the heat sink 4 is attached to an inner wall of the inner diffusion cover 3, the heat sink 4 is provided with an opening facing the outer diffusion cover 1, the main light source assembly 6 is arranged on an inner bottom wall of the heat sink 4 and is arranged towards the opening, and the backlight source assembly 5 is arranged on an outer bottom wall of the heat sink 4.

The side wall of the heat sink 4 is attached to the inner wall of the inner diffusion cover 3, which can increase a heat dissipation area, simultaneously export the heat generated by the main light source assembly 6 and the backlight source assembly 5 during operation, avoid the problem that a traditional single light source heat dissipation structure cannot meet requirements of heat dissipation of dual light sources, and prolong the service life of the main light source assembly 6 and the backlight source assembly 5. The opening of the heat sink 4 is opposite to the main light source assembly 6, which can ensure that the light from the main light source assembly 6 is emitted directly towards the front. The backlight source assembly 5 is arranged on the outer bottom wall of the heat sink 4, which can ensure that the light from the backlight source assembly 5 is emitted towards the inner diffusion cover 3, thus preventing the light from dual light sources from interfering with each other.

Referring to FIG. 2, FIG. 3, and FIG. 4, the backlight source assembly 5 includes a backlight source board 51 and a plurality of first LED lamp beads 52, where the backlight source board 51 is arranged on an end face of the heat sink 4 facing away from the outer diffusion cover 1, and the plurality of first LED lamp beads 52 are uniformly arranged along the edge of the backlight source board 51 facing away from an end face of the heat sink 4.

The plurality of first LED lamp beads 52 of the backlight source assembly 5 are evenly distributed along the edge of the backlight source board 51, which, in conjunction with the diffusion effect of the inner diffusion cover 3, enables the back light to be evenly covered, thus solving the problem of uneven lighting brightness at the back and side, and ensuring an overall effect of night lamps or atmosphere lighting.

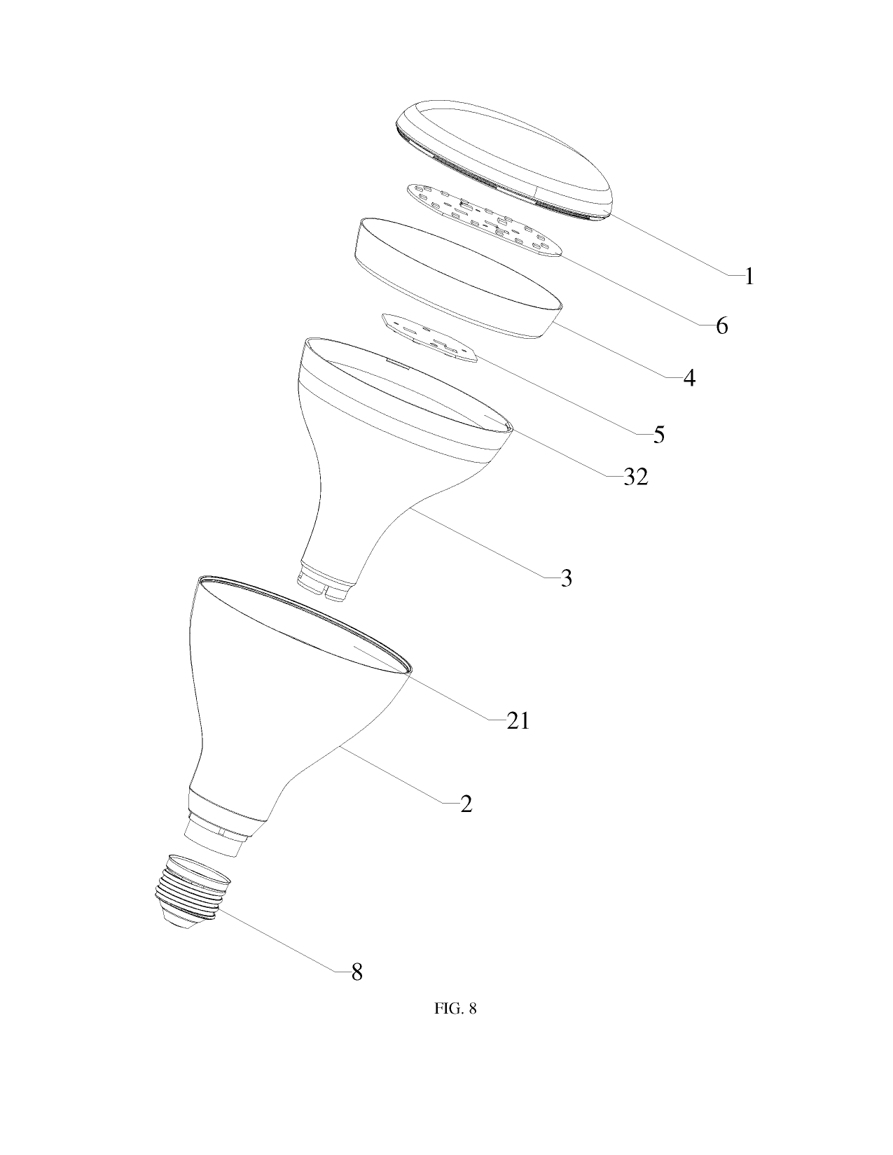

In some embodiments, referring to FIG. 2, FIG. 3, and FIG. 7, the main light source assembly 6 includes a main light source board 61 and a plurality of second LED lamp beads 62, where the main light source board 61 is arranged on an end face of the heat sink 4 facing the outer diffusion cover 1, and the plurality of second LED lamp beads 62 are uniformly arranged along the edge of the main light source board 61 facing away from an end face of the heat sink 4.

The second LED lamp beads 62 of the main light source assembly 6 are evenly distributed along the edge of the main light source board 61, which, in conjunction with the diffusion effect of the inner diffusion cover 1, enables front lighting light to be evenly covered, thus solving the problem of uneven brightness of front lighting of traditional light sources, and improving conventional lighting experience.

In some embodiments, referring to FIG. 1, FIG. 2, and FIG. 8, the light source structure 100 further includes a lamp cap 8, where the lamp cap 8 is mounted at one end of the plastic shell 2 facing away from the outer diffusion cover 1.

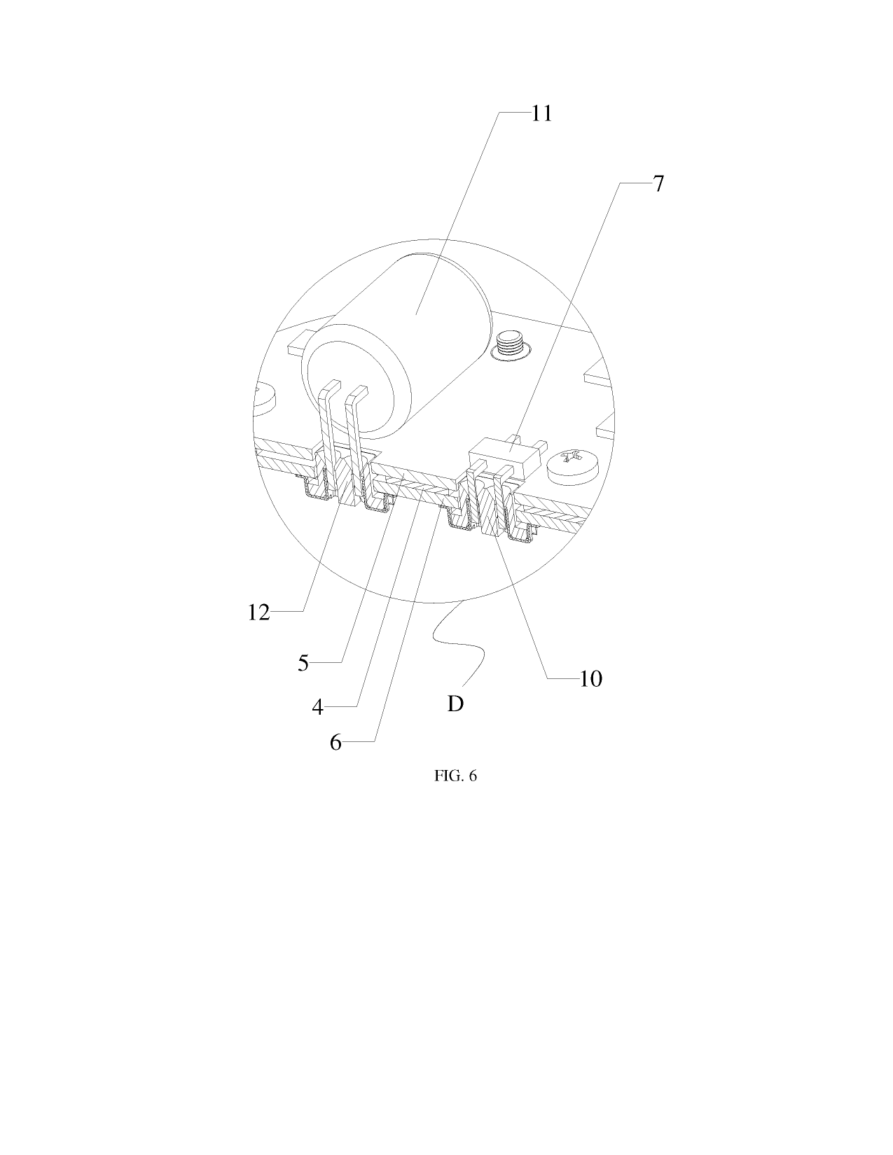

Referring to FIG. 4, FIG. 5, and FIG. 7, a side surface of the backlight source assembly 5 far away from the heat sink 4 is welded with a connector plug 7, and a side surface of the main light source assembly 6 far away from the heat sink 4 is welded with a first connector receptacle 10; and the first connector receptacle 10 sequentially penetrates the main light source assembly 6 and the heat sink 4 and extends into the backlight source assembly 5, and a pin of the connector plug 7 is inserted into the first connector receptacle 10 to form an electrical connection between the main light source assembly 6 and the backlight source assembly 5.

By welding the connector plug 7 on the backlight source assembly 5, welding the penetrating first connector receptacle 10 on the main light source assembly 6, and inserting the pin into the receptacle to realize the electrical connection, not only a traditional complicated welding step is omitted, but also an assembling process of the BR bulb is simplified, so that not only the production efficiency is improved, but also the problem of loose wires is avoided, thus ensuring the stability of the electrical connection between the main light source assembly 6 and the backlight source assembly 5, adapting to a compact internal structure of the BR bulb, and having no interference in its lighting function by using a space of the heat sink 4 to hide wires.

In some embodiments, referring to FIG. 4, FIG. 5, and FIG. 6, a side surface of the backlight source assembly 5 far away from the heat sink 4 is provided with a first capacitor 11, and a side surface of the main light source assembly 6 far away from the heat sink 4 is provided with a second connector receptacle 12; and the second connector receptacle 12 sequentially penetrates the main light source assembly 6 and the heat sink 4 and extends into the backlight source assembly 5, and a pin of the first capacitor 11 is inserted into the second connector receptacle 12.

The connection is realized by inserting the pin of the first capacitor 11 into the penetrating second connector receptacle 12 without welding, which not only can simplify the assembling process and avoid damaging the capacitor at high temperature, ensuring the stable function of capacitor filtering and voltage stabilization, and reducing light source flickering, but also can separate a capacitor line from power supply lines of the main light source assembly 6 and the backlight source assembly 5, to avoid circuit interference, and reduce maintenance costs since the whole bulb doe not need to be disassembled when replacing the capacitor in a later period.

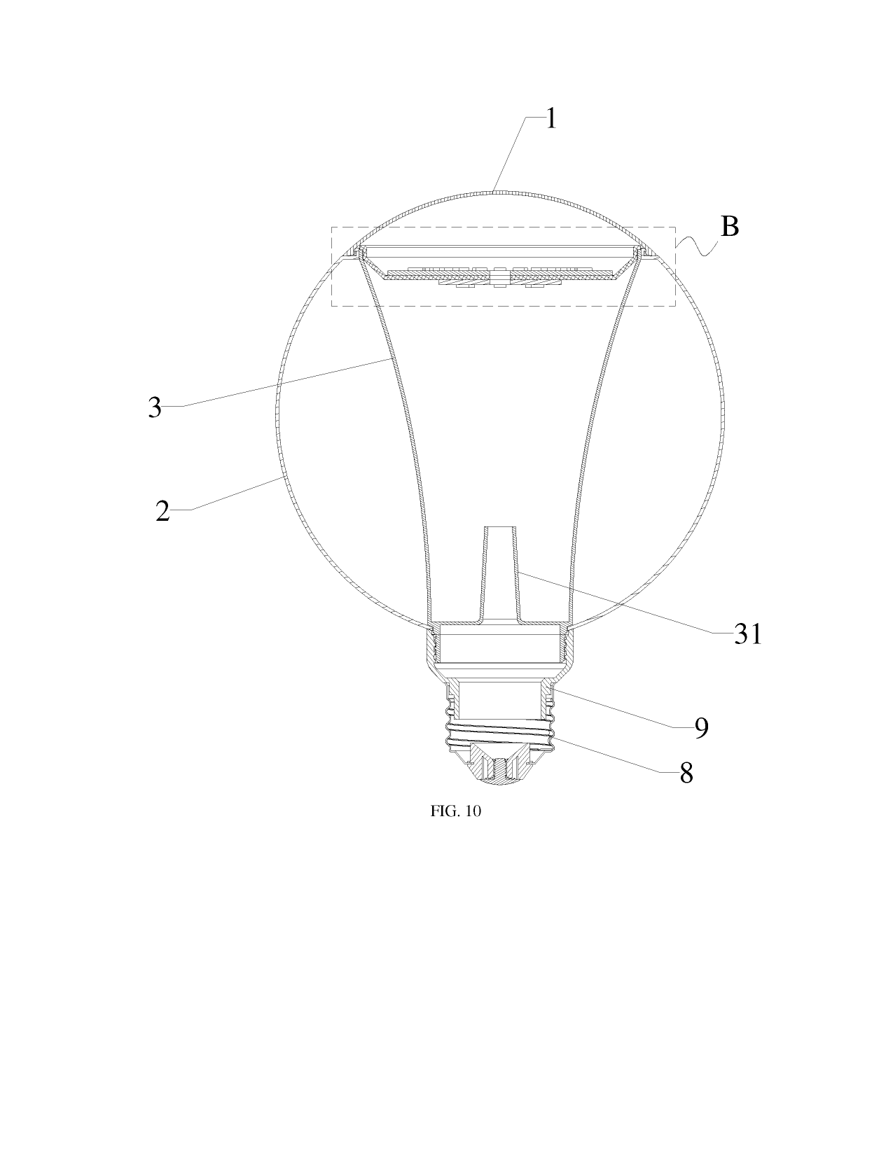

In some embodiments, referring to FIG. 10, the outer shell is spherical, and the inner diffusion cover 3 is trumpet-shaped.

For a globe shape bulb, the outer shell is limited to be spherical and the inner diffusion cover 3 to be trumpet-shaped, so the spherical outer shell can adapt to a spherical structure of the globe shape bulb, and the trumpet-shaped inner diffusion cover 3 can fully diffuse the light from the backlight source assembly 5 and then emit the light at 360° through the spherical plastic shell, so as to realize surrounding atmosphere lighting.

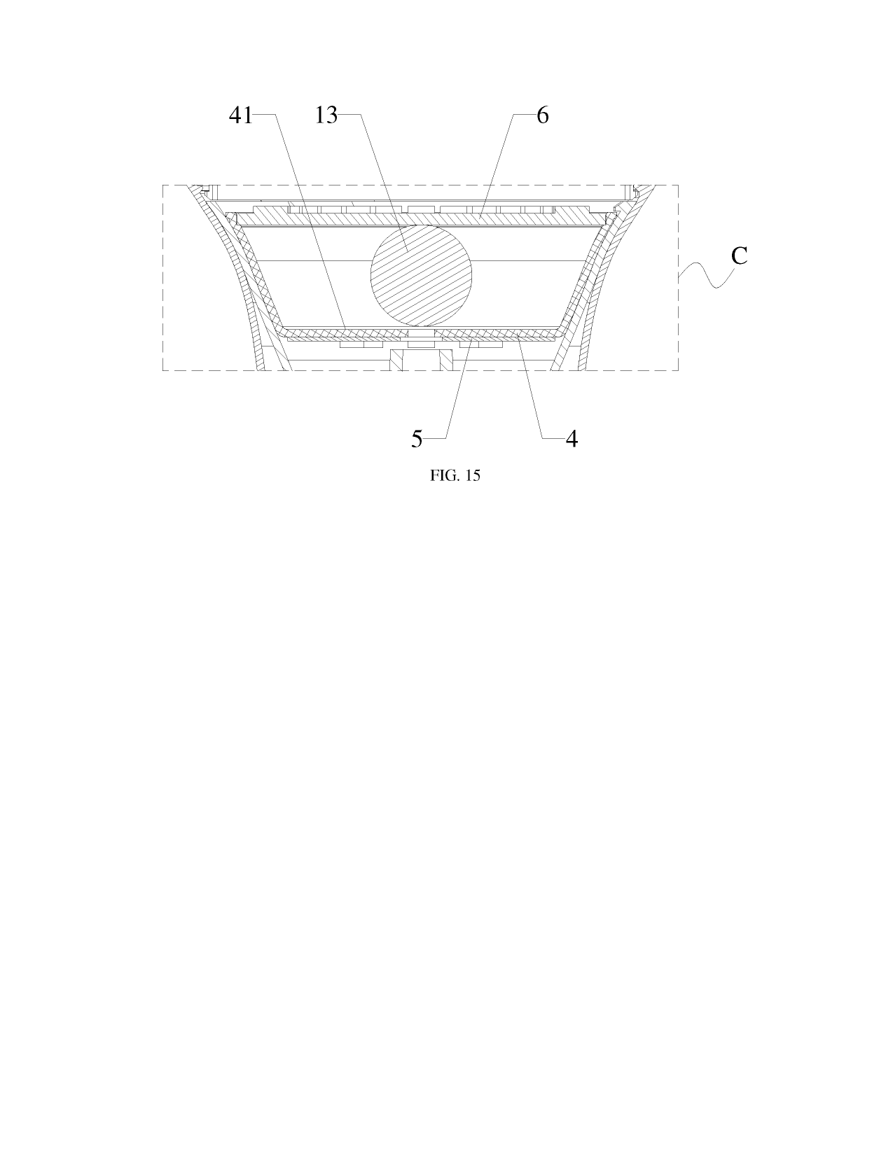

In some embodiments, referring to FIG. 15, a second capacitor 13 is arranged between the main light source assembly 6 and an inner bottom wall 41 of the heat sink 4, the second capacitor 13 is electrically connected to the main light source assembly 6, and the main light source assembly 6 is arranged at the opening of the heat sink 4 in a covering manner.

For an A-series light bulb, due to a small internal space of the A-series light bulb, there is not enough space for the main light source assembly 6 and backlight source assembly 5 to place devices, so that the second capacitor 13 is hidden between the main light source assembly 6 and the inner bottom wall 41 of the heat sink 4 (that is, an inner chamber of the heat sink 4), which does not affect front and back lighting effects.

Referring to FIG. 1, FIG. 2, and FIG. 3, a light source structure 100 includes an outer diffusion cover 1, a transparent plastic shell 2, and a colored inner diffusion cover 3, where the plastic shell 2 is provided with a first opening 21, the inner diffusion cover 3 is provided with a second opening 32 in a same direction as the first opening 21, the plastic shell 2 is sleeved outside the inner diffusion cover 3, the outer diffusion cover 1 is arranged at the first opening 21 in a covering manner, and the outer diffusion cover 1 and the plastic shell 2 enclose to form an outer shell (1 and 2) of the light source structure 100; and a heat sink 4 is arranged inside the inner diffusion cover 3, the heat sink 4 is provided with a main light source assembly 6 at one side facing the outer diffusion cover 1 and is provided with a backlight source assembly 5 at one side facing the plastic shell 2, and the backlight source assembly 5 is electrically connected to the main light source assembly 6.

Referring to FIG. 2, the inner diffusion cover 3 is amber in color.

A visible light transmittance of the inner diffusion cover 3 ranges from 65% to 87%.

An inner surface of one end of the inner diffusion cover 3 facing away from the outer diffusion cover 1 is provided with a threading post 31 extending in an axial direction of the inner diffusion cover 3, and the threading post 31 is integrally formed together with the inner diffusion cover 3.

Referring to FIG. 4 and FIG. 7, the heat sink 4 is in a circular truncated cone shape, a side wall of the heat sink 4 is attached to an inner wall of the inner diffusion cover 3, the heat sink 4 is provided with an opening facing the outer diffusion cover 1, the main light source assembly 6 is arranged on an inner bottom wall of the heat sink 4 and is arranged towards the opening of the heat sink 4, and the backlight source assembly 5 is arranged on an outer bottom wall of the heat sink 4.

Referring to FIG. 2, FIG. 3, and FIG. 4, the backlight source assembly 5 includes a backlight source board 51 and a plurality of first LED lamp beads 52, where the backlight source board 51 is arranged on an end face of the heat sink 4 facing away from the outer diffusion cover 1, and the plurality of first LED lamp beads 52 are uniformly arranged along the edge of the backlight source board 51 facing away from an end face of the heat sink 4.

Referring to FIG. 2, FIG. 3, and FIG. 7, the main light source assembly 6 includes a main light source board 61 and a plurality of second LED lamp beads 62, where the main light source board 61 is arranged on an end face of the heat sink 4 facing the outer diffusion cover 1, and the plurality of second LED lamp beads 62 are uniformly arranged along the edge of the main light source board 61 facing away from an end face of the heat sink 4.

Referring to FIG. 1, FIG. 2, and FIG. 8, the light source structure 100 further includes a lamp cap 8, where the lamp cap 8 is mounted at one end of the plastic shell 2 facing away from the outer diffusion cover 1.

A working process of the above-mentioned light source structure 100 is as follows: after the lamp cap 8 is connected to mains electricity, a current is transmitted to the main light source assembly 6 and the backlight source assembly 5 through the lamp cap 8; the second LED lamp beads 62 of the main light source assembly 6 emit light, and the light is emitted from the front after being diffused by the outer diffusion cover 1, so as to realize conventional lighting and meet basic lighting requirements of daily living rooms, bedrooms, and other spaces; the first LED lamp beads 52 of the backlight source assembly 5 emit light, and the light is diffused and softened first by the amber inner diffusion cover 3, and then emitted from the back and side through the transparent plastic shell 2, so as to form soft and warm yellow light, thus realizing soft atmosphere lighting; and a user can independently control ON/OFF and brightness of the main light source assembly 6 or the backlight source assembly 5 through an external switch or a dimming module according to usage scenario requirements. For example, only the backlight source assembly 5 is turned on at night as a night lamp, the main light source assembly 6 is turned on during daily activities as a regular lighting lamp, and dual lighting functions are simultaneously activated for party time to create a rich space atmosphere.

Referring to FIG. 1 to FIG. 8, in some embodiments of this disclosure, a BR bulb is provided, including a light source structure 100 in the above-mentioned embodiments.

Referring to FIG. 4, FIG. 5, and FIG. 7, a side surface of the backlight source assembly 5 far away from the heat sink 4 is welded with a connector plug 7, and a side surface of the main light source assembly 6 far away from the heat sink 4 is welded with a first connector receptacle 10; and the first connector receptacle 10 sequentially penetrates the main light source assembly 6 and the heat sink 4 and extends into the backlight source assembly 5, and a pin of the connector plug 7 is inserted into the first connector receptacle 10 to form an electrical connection between the main light source assembly 6 and the backlight source assembly 5.

Referring to FIG. 4, FIG. 5, and FIG. 6, a side surface of the backlight source assembly 5 far away from the heat sink 4 is provided with a first capacitor 11, and a side surface of the main light source assembly 6 far away from the heat sink 4 is provided with a second connector receptacle 12; and the second connector receptacle 12 sequentially penetrates the main light source assembly 6 and the heat sink 4 and extends into the backlight source assembly 5, and a pin of the first capacitor 11 is inserted into the second connector receptacle 12.

Referring to FIG. 2, the inner diffusion cover 3 is adapted to the plastic shell 2 in shape.

Application scenarios of the BR bulb in this embodiment: living room scenario: the main light source assembly 6 is turned on for daily activities to realize overall conventional lighting; when at night or watching movies, the main light source assembly 6 is turned off and the backlight source assembly 5 is turned on, providing soft light to create a warm atmosphere, thus avoiding bright light from affecting movie-viewing experience; and bedroom scenario: the main light source assembly 6 is turned on before bedtime to meet the needs of sorting clothes and reading; when getting up at night to urinate, only the backlight source assembly 5 is turned on as a night lamp, providing soft light without affecting other people to rest.

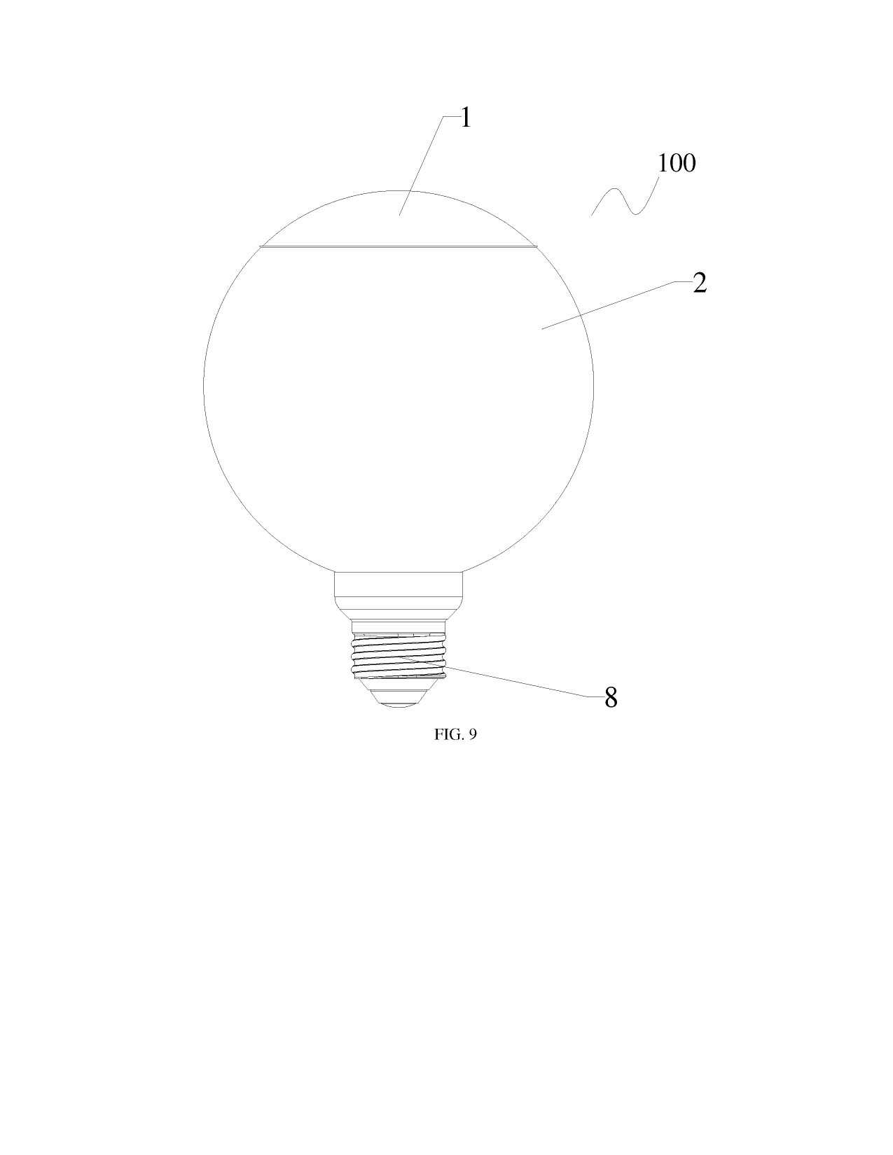

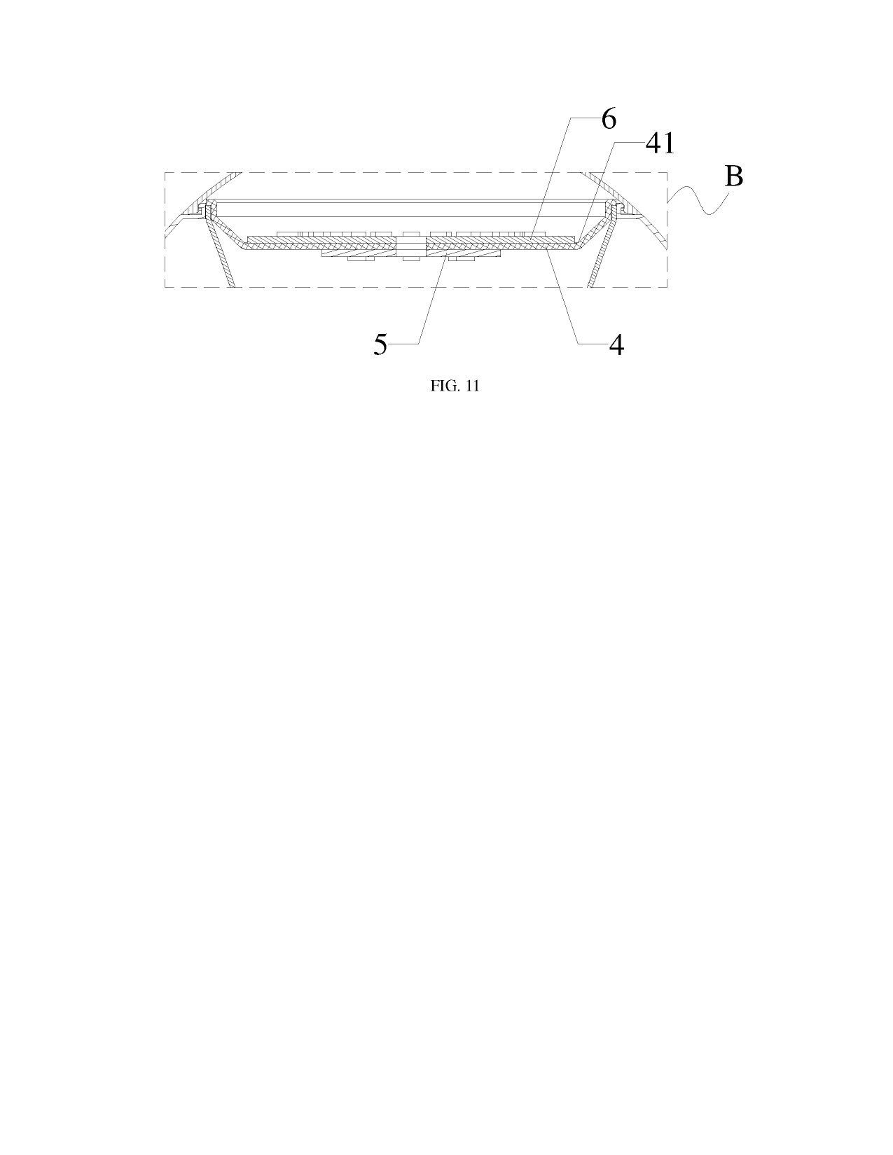

Referring to FIG. 9 to FIG. 12, in some embodiments of this disclosure, a globe shape bulb is provided, including a light source structure 100 in the above-mentioned embodiments.

Component adjustment of the globe shape bulb compared with the BR bulb: the transparent plastic shell 2 is changed into a spherical bulb shell, and a fixed member 9 is added to connect the bulb shell with the lamp cap 8; and the heat sink 4 is changed into a flat-circular truncated cone shape to save the internal space.

Referring to FIG. 10, the outer shell (1 and 2) is spherical, and the inner diffusion cover 3 is trumpet-shaped.

Function realization: the main light source assembly 6 meets the requirements for basic lighting of restaurants and bars; after the light from the backlight source assembly 5 is softened by the inner diffusion cover 3, a warm atmosphere (such as a dinner party or leisure scenario) is created through a thin-necked bulb shell.

Application scenarios of the globe shape bulb in this embodiment: restaurant scenario: the main light source assembly 6 is turned on at meals to ensure clear vision, and the backlight source assembly 5 emits soft atmosphere light to enhance the dining experience; and bar scenario: the main light source assembly 6 meets the requirements of beverage production and display, and the backlight source assembly 5 combines with a bar decoration style to create a relaxing and leisurely atmosphere.

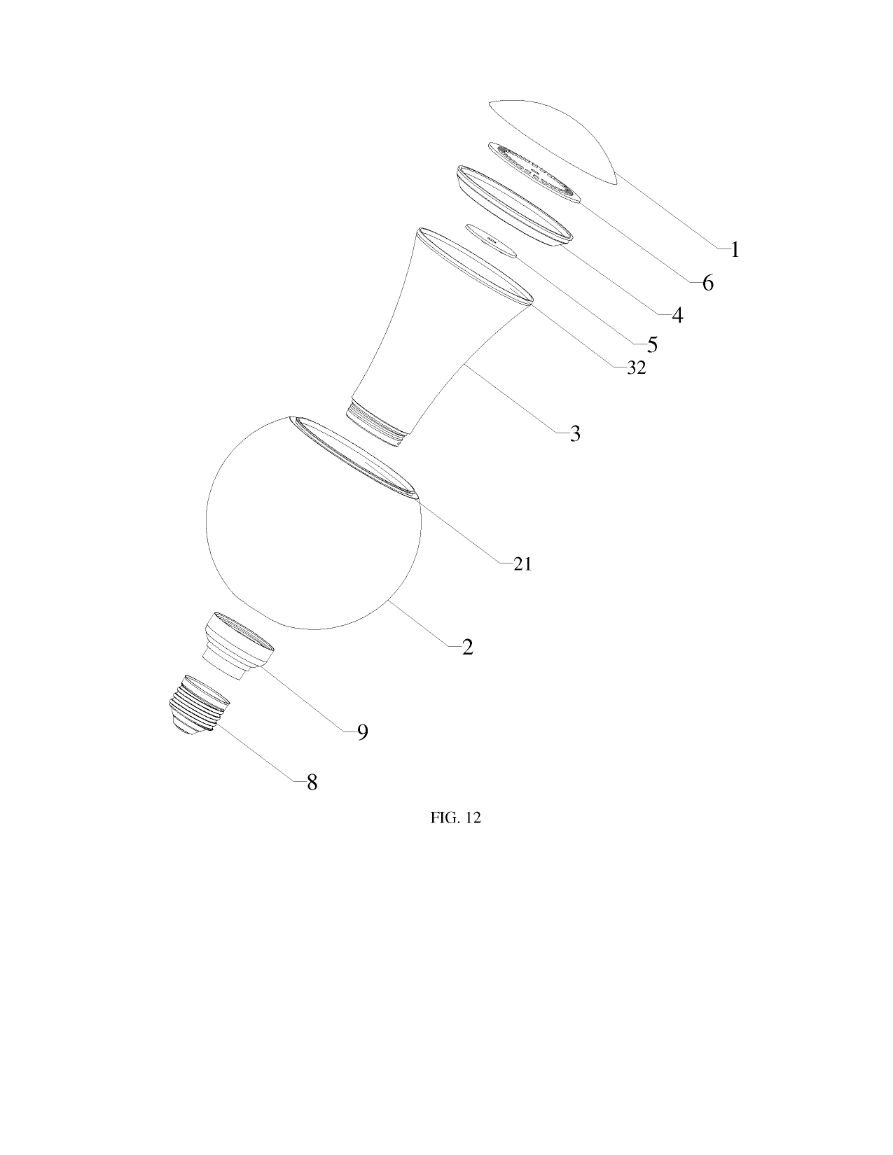

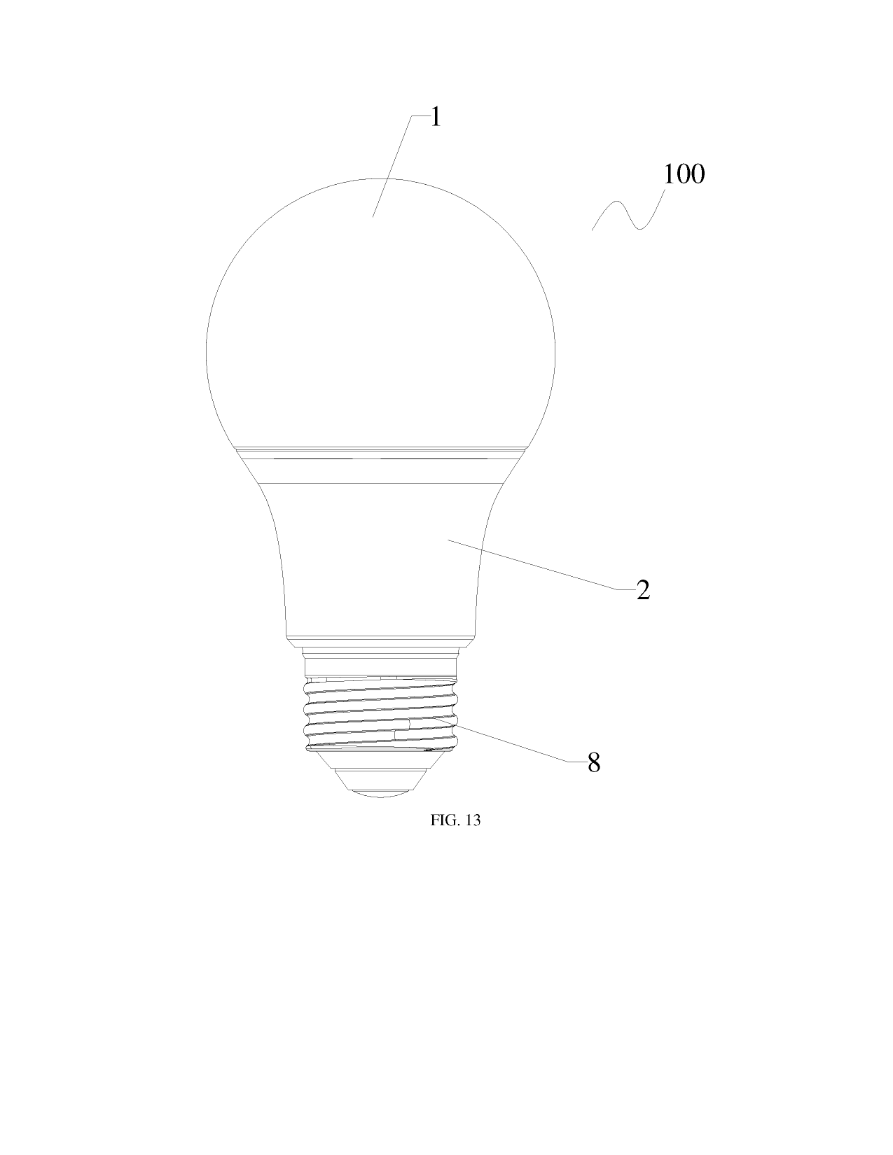

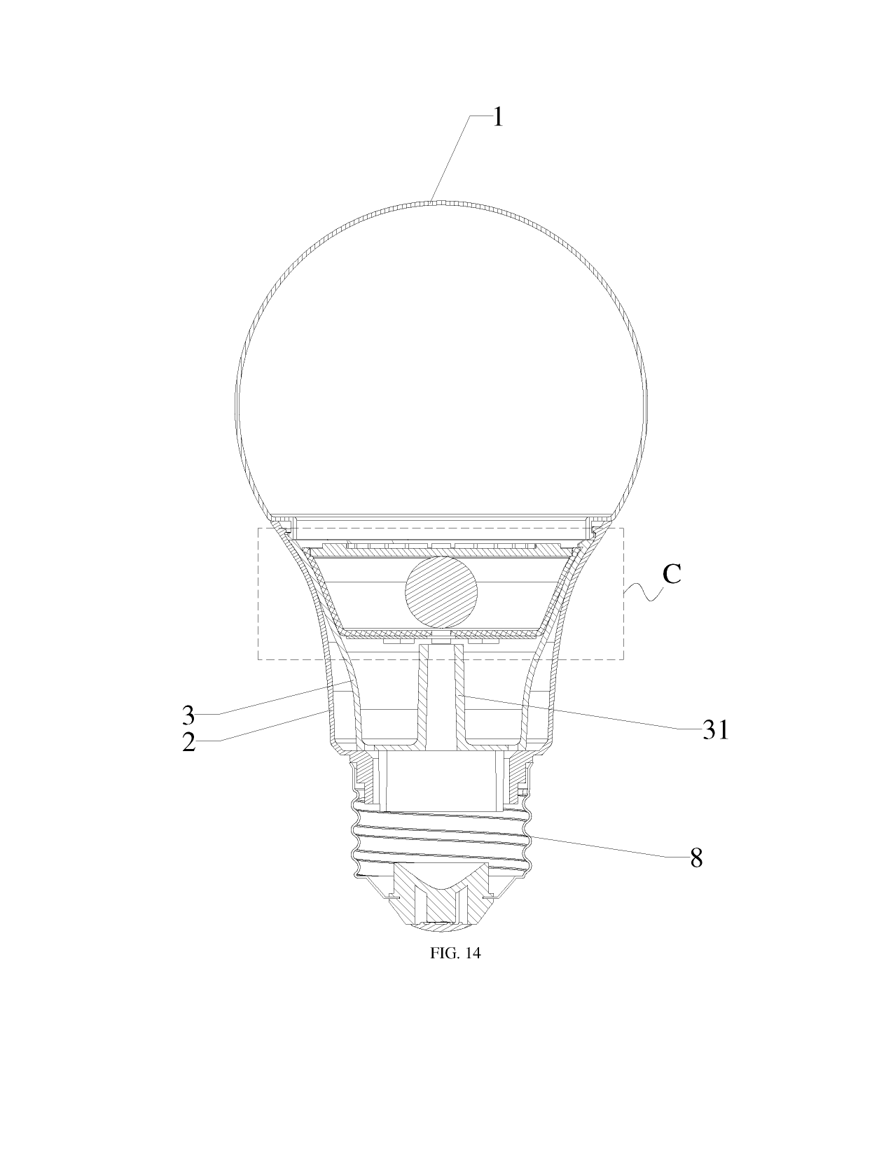

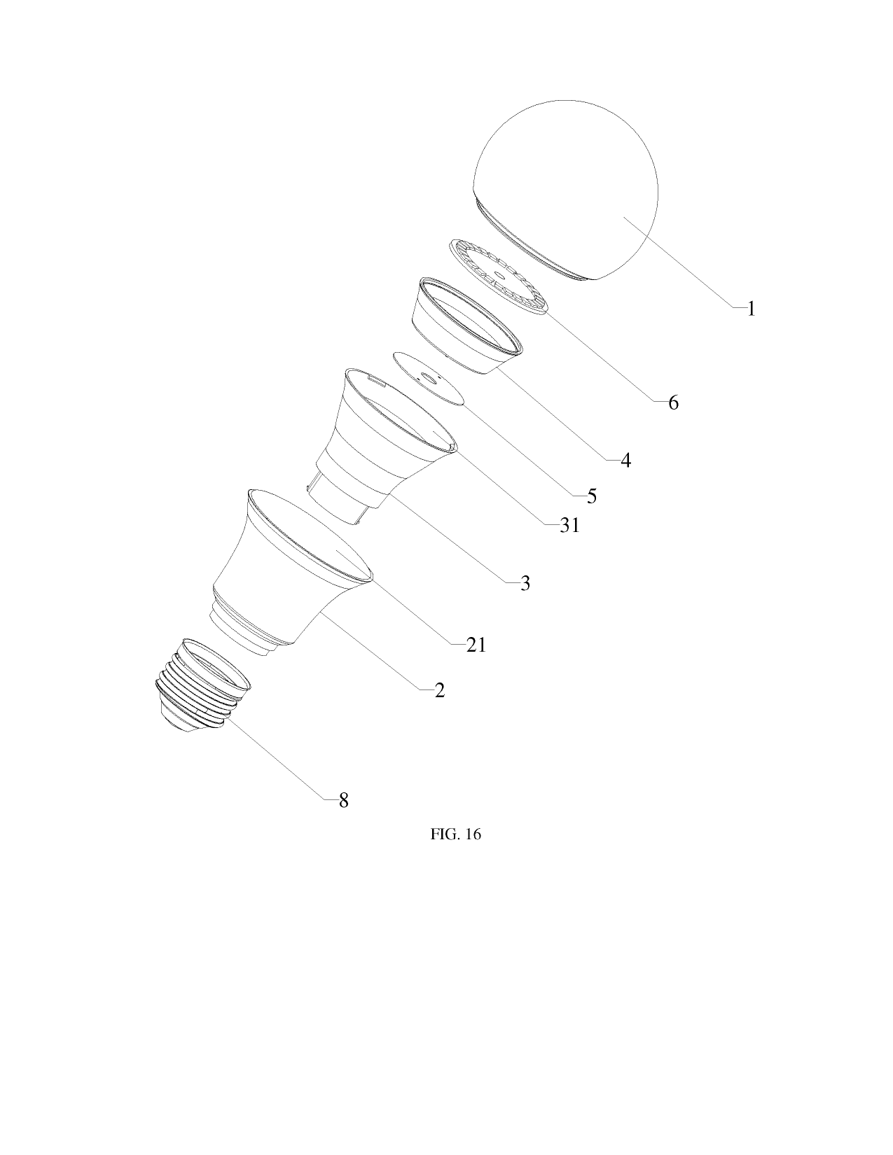

Referring to FIG. 12 to FIG. 16, in some embodiments of this disclosure, an A-series light bulb is provided, including a light source structure 100 in the above-mentioned embodiments.

Component adjustment of the A-series light bulb compared with the BR bulb: the outer diffusion cover 1 is changed into a spherical bulb shell.

Referring to FIG. 13, the outer shell (1 and 2) is pear-shaped.

Referring to FIG. 15, a second capacitor 13 is arranged between the main light source assembly 6 and an inner bottom wall 41 of the heat sink 4, the second capacitor is electrically connected to the main light source assembly 6, and the main light source assembly 6 is arranged at the opening of the heat sink 4 in a covering manner.

Function realization: the main light source assembly 6 meets the requirements for conventional lighting of small spaces such as bedrooms and corridors; the backlight source assembly 5 emits soft light through the inner diffusion cover 3 and the spherical bulb shell, which is used as a bedside night lamp to avoid bright light from dazzling.

Application scenarios of the A-series light bulb in this embodiment: bedroom bedside scenario: the main light source assembly 6 is used for reading before bedtime, and the backlight source assembly 5 is used as an ever-burning lamp at night, providing low brightness to ensure nighttime safety; and corridor scenario: the main light source assembly 6 meets the requirements for daily access lighting, and the backlight source assembly 5 is used as an energy-saving lighting lamp at night (low power consumption and long service life).

In conclusion, in the light source structure provided in this disclosure, in some embodiments, the heat sink is used as a carrier, and the main light source assembly is arranged at the side of the heat sink facing the outer diffusion cover, so as to realize a conventional front lighting function of a traditional light source. Meanwhile, the backlight source assembly is arranged at the side of the heat sink facing the plastic shell, and is matched with the colored inner diffusion cover and the transparent plastic shell, so that a light emitting direction of the backlight source assembly is towards the inner diffusion cover, instead of directly illuminating a user's activity area, thereby avoiding direct lighting of bright light; and the transparent plastic shell allows the soft light treated by the inner diffusion cover to penetrate smoothly, forming a “surrounding” soft lighting form from the back and side of a lamp body, which is more suitable for the requirements of “low-range and local lighting” of a night lamp (for example, a bedside night lamp only needs to light the area around the bed) and “large-area and background lighting” of atmosphere lighting (for example, a living room lamp lights the wall through back light to form indirect atmosphere light), thus realizing dual functions of conventional lighting and soft atmosphere lighting. The inner diffusion cover in this solution is arranged inside the plastic shell, which can shield the main light source assembly, the backlight source assembly, the heat sink, and internal electronic components, to avoid seeing messy devices from the outside on the one hand, and can diffuse and soften the light from the backlight source assembly, to ensure the softness of the light of the night lamp and atmosphere lighting on the other hand.

The above descriptions are only the embodiments of this disclosure and do not limit the patent scope of this disclosure. Any equivalent transformation made according to the specification and the content of the accompanying drawings of this disclosure or directly or indirectly used in related technical fields is included in the patent protection scope of this disclosure in the same way.

What is claimed is:

1. A light source structure, comprising an outer diffusion cover, a transparent plastic shell, and a colored inner diffusion cover,
wherein the plastic shell is sleeved outside the inner diffusion cover, and the outer diffusion cover and the plastic shell enclose to form an outer shell of the light source structure; and
a heat sink is arranged inside the inner diffusion cover, the heat sink is provided with a main light source assembly at one side facing the outer diffusion cover and is provided with a backlight source assembly at one side facing the plastic shell, and the backlight source assembly is electrically connected to the main light source assembly.

2. The light source structure according to claim 1, wherein the inner diffusion cover is amber in color.

3. The light source structure according to claim 1, wherein a visible light transmittance of the inner diffusion cover ranges from 65% to 87%.

4. The light source structure according to claim 1, wherein an inner surface of one end of the inner diffusion cover facing away from the outer diffusion cover is provided with a threading post extending in an axial direction of the inner diffusion cover.

5. The light source structure according to claim 1, wherein the heat sink is in a circular truncated cone shape, a side wall of the heat sink is attached to an inner wall of the inner diffusion cover, the heat sink is provided with an opening facing the outer diffusion cover, the main light source assembly is arranged on an inner bottom wall of the heat sink and is arranged towards the opening of the heat sink, and the backlight source assembly is arranged on an outer bottom wall of the heat sink.

6. The light source structure according to claim 5, wherein a second capacitor is arranged between the main light source assembly and an inner bottom wall of the heat sink, the second capacitor is electrically connected to the main light source assembly, and the main light source assembly is arranged at the opening of the heat sink in a covering manner.

7. The light source structure according to claim 1, further comprising a lamp cap, wherein the lamp cap is mounted at one end of the plastic shell facing away from the outer diffusion cover.

8. The light source structure according to claim 1, wherein a side surface of the backlight source assembly far away from the heat sink is welded with a connector plug, and a side surface of the main light source assembly far away from the heat sink is welded with a first connector receptacle; and
the first connector receptacle sequentially penetrates the main light source assembly and the heat sink and extends into the backlight source assembly, and a pin of the connector plug is inserted into the first connector receptacle to form an electrical connection between the main light source assembly and the backlight source assembly.

9. The light source structure according to claim 1, wherein a side surface of the backlight source assembly far away from the heat sink is provided with a first capacitor, and a side surface of the main light source assembly far away from the heat sink is provided with a second connector receptacle; and
the second connector receptacle sequentially penetrates the main light source assembly and the heat sink and extends into the backlight source assembly, and a pin of the first capacitor is inserted into the second connector receptacle.

10. The light source structure according to claim 1, wherein the outer shell is spherical, and the inner diffusion cover is trumpet-shaped.
